(19) United States
(12) Patent Application Publication
(10) Pub. No.: US 2025/0054481 A1
(43) Pub. Date: Feb. 13, 2025

(54) METHOD OF SUPPRESSING WIND NOISE OF MICROPHONE AND ELECTRONIC DEVICE

(71) Applicant: Samsung Electronics Co., Ltd., Suwon-si (KR)

(72) Inventor: Yanhong LI, Suzhou (CN)

(73) Assignee: Samsung Electronics Co., Ltd., Suwon-si (KR)

(21) Appl. No.: 18/767,432

(22) Filed: Jul. 9, 2024

(30) Foreign Application Priority Data
Aug. 10, 2023 (CN) 202311003401.8

(51) Int. Cl. G10K 11/178; G10L 21/0216; G10L 21/0224; H04R 1/08

(52) U.S. Cl. CPC G10K 11/17823; G10L 21/0224; H04R 1/08; G10L 2021/02166; H04R 2410/05; H04R 2410/07

(57) ABSTRACT

A method of suppressing wind noise of microphone and an electronic device are disclosed. The method comprises: receiving a plurality of audio signals from a plurality of microphones; detecting presences of wind noise and voice in the plurality of audio signals; determining one of the plurality of audio signals as a reference signal based on a result of detecting the presences of wind noise and voice, the plurality of audio signals including the one of the plurality of audio signals and remaining audio signals; performing compensation operation on each of the remaining audio signals, based on the determined reference signal; and obtaining modified audio signals based on the remaining audio signals on which the compensation operation is performed.

### CROSS-REFERENCE TO RELATED APPLICATIONS

This application claims priority under 35 U.S.C. § 119 to Chinese Patent Application No. 202311003401.8, filed on Aug. 10, 2023, in the State Intellectual Property Office of the P.R.C., the disclosure of which is incorporated herein in its entirety by reference.

### BACKGROUND

Some example embodiments relate to audio processing, and more particularly, to a method of suppressing wind noise of microphone and/or an electronic device.

With the development of technology, portable terminals are widely used. Many portable terminals support audio collection functions. The portable terminals can collect audio signals through a microphone, and then process the collected audio signals. However, when the audio signal (e.g., voice signal) is collected through the microphone, the audio signal may sometimes unavoidably be affected by wind noise due to the air turbulence on the microphone surface, which may affect the quality of the collected audio signal. However, existing wind noise suppression technology may lead to the distortion of audio signal.

### SUMMARY

This summary is provided to introduce a selection of concepts in a simplified form that are further described below in the Detailed Description. This summary is not intended to identify key features and/or essential features of the claimed subject matter, nor is it intended to be used as an aid in determining the scope of the claimed subject matter.

According to some example embodiments, a method of suppressing wind noise of microphone comprises: receiving a plurality of audio signals from a plurality of microphones; detecting presences of wind noise and voice in the plurality of audio signals; determining one of the plurality of audio signals as a reference signal, based on a result of detecting the presences of wind noise and voice, the plurality of audio signals including the one of the plurality of audio signals and remaining audio signals; performing compensation operation on each of the remaining audio signals, based on the determined reference signal; and obtaining modified audio signals based on the remaining audio signals on which the compensation operation is performed.

According to some example embodiments, an electronic device comprises, a microphone unit configured to collect a plurality of audio signals, wherein the microphone unit includes a plurality of microphones, and each of the microphones collects one of the plurality of audio signals; and an audio processor configured to, receive the plurality of audio signals from the plurality of microphones; detect presences of wind noise and voice in the plurality of audio signals; determine one of the plurality of audio signals as a reference signal, base on a result of detecting the presences of wind noise and voice, the plurality of audio signals including the one of the plurality of audio signals and remaining audio signals; perform compensation operation on each of remaining audio signals, based on the determined reference signal; and obtain modified audio signals based on the remaining audio signals on which the compensation operation is performed.

According to some example embodiments, a non-transitory computer-readable storage medium stores instructions that, when executed by a processor, cause the processor to execute the method disclosed above.

The method of suppressing wind noise of microphone and the electronic device according to some example embodiments of inventive concepts may effectively retain the low-frequency harmonic of the audio signal while suppressing wind noise, so as to reduce the distortion of the audio signal.

Other aspects and/or advantages of inventive concepts will be partially described in the following description, and part will be clear through the description and/or may be learn through the practice of various example embodiments.

### BRIEF DESCRIPTION OF THE DRAWINGS

The above and other objects, features and advantages of the present disclosure will become clearer through the following detailed description together with the accompanying drawings in which:

FIG. 1 is a block diagram showing an electronic device according to some example embodiments;

FIG. 2 is a flowchart illustrating a method of suppressing wind noise of microphone according to some example embodiments;

FIG. 3 shows a flowchart of a method of performing compensation operation according to some example embodiments;

FIG. 4 is a block diagram illustrating an example structure of an adaptive filter according to some example embodiments; and

FIG. 5 shows a block diagram of a mobile terminal according to some example embodiments.

### DETAILED DESCRIPTION OF EXAMPLE EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed herein are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concepts of the present disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c”, “at least one of a, b, and c,” and “at least one selected from the group consisting of a, b, and c” indicates only a, only b, only c, both a and b, both a and c, both b and c, all of a, b, and c, or variations thereof.

Unless otherwise defined, all terms including technical or scientific terms used herein have the same meaning as commonly understood by one of ordinary skill in the art to which examples belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

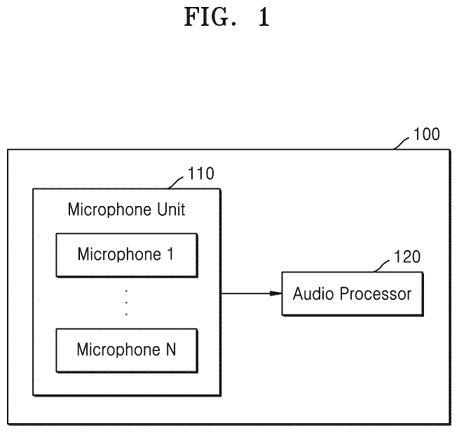

FIG. 1 is a block diagram showing an electronic device according to some example embodiments.

The electronic device according to various example embodiments may include, for example, at least one of mobile phone, wireless headphone, recording pen, tablet personal computer (PC), personal digital assistant (PDA), portable multimedia player (PMP), augmented reality (AR) device, virtual reality (VR) device, various wearable devices (e.g. smart watch, smart glasses, smart bracelet, etc.). However, example embodiments are not limited to these, and the electronic device according to inventive concepts may be any electronic device having an audio collection function.

As shown in FIG. 1, the electronic device 100 according to some example embodiments of inventive concepts at least includes a microphone unit 110 and an audio processor 120.

The microphone unit 110 may collect sound from the outside, and may convert the collected sound into an electrical signal as an audio signal. Herein, the microphone unit 110 may include a plurality of microphones. For example, the microphone unit 110 may include microphone 1 to microphone N, wherein N is a natural number greater than 1. Depending on the need and/or the design, the microphone unit 110 may output the audio signal in an analog form (e.g., as analog audio signal) and/or the audio signal in a digital form (e.g., digital audio signal).

The audio processor 120 may process the audio signal to perform a wind noise cancellation or wind noise reduction operation.

In a case where the microphone unit 110 outputs the audio signal in analog form, the audio processor 120 may convert the audio signal in an analog form received from the microphone unit 110 into the audio signal in a digital form. In a case where the microphone unit 110 outputs the audio signal in a digital form, the audio processor 120 may process or directly process the audio signal in digital form received from the microphone unit 110, e.g., the audio processor 120 may process the audio signal without processing on an analog signal.

The audio processor 120 receives a plurality of audio signals from the microphone unit 110; detect presences of wind noise and voice in each of (or alternatively, at least one of) the plurality of audio signals; determine one of the plurality of audio signals as a reference signal, according to or based on a result of detecting the presences of wind noise and voice; perform compensation operation on each of (or alternatively, at least one of) the remaining audio signals of the plurality of audio signals, based on the determined reference signal; and obtain modified audio signals (e.g., audio signals in which wind noise has been removed), based on the audio signals on which the compensation operation is performed. The audio processor 120 may output the modified audio signals.

The audio processor 120 may be implemented as hardware such as general-purpose processor, application processor (AP), integrated circuit dedicated to audio processing, field programmable gate array, or a combination of hardware and software.

In some example embodiments, the electronic device 100 may also include a memory (not shown). The memory may store data and/or software for implementing a method of suppressing wind noise of microphone according to some example embodiments. When the audio processor 120 executes the software, the method of suppressing wind noise of microphone according to some example embodiments of inventive concepts may be implemented. In addition, the memory may also be used to store the corrected audio signal; however, example embodiments are not limited thereto, and the corrected audio signal may not be stored in the electronic device 100.

In some example embodiments, the microphone unit 110 and the audio processor 120 may be installed in different devices. For example, the microphone unit 110 may provide, through wired communication and/or wireless communication, the audio signal to the audio processor 120 for processing.

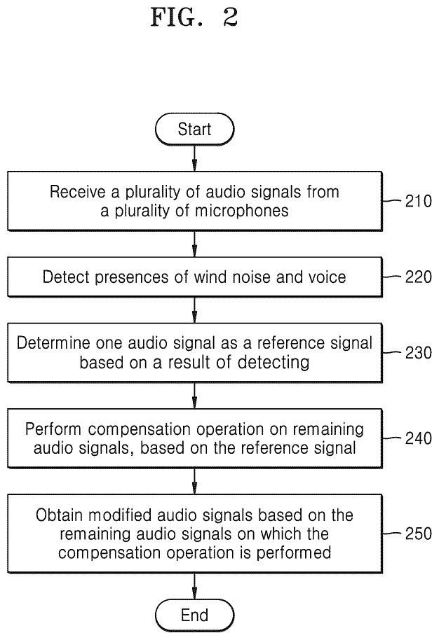

The method of suppressing wind noise of microphone according to some example embodiments of inventive concepts is described below in connection with FIG. 2.

FIG. 2 is a flowchart showing the method of suppressing wind noise of microphone according to some example embodiments of inventive concepts. Although FIG. 2 illustrates various steps, an order of the steps is not necessarily limited to the order presented in FIG. 2.

Referring to FIG. 2, in step 210, the audio processor 120 receives a plurality of audio signals from a plurality of microphones of the microphone unit 110.

In step 220, the audio processor 120 detects presences of wind noise and voice in each of (or alternatively, at least one of) the plurality of audio signals.

For example, the audio processor 120 may obtain a frequency spectrum and a power spectrum of each of (or alternatively, at least one of) the plurality of audio signals, extract features based on the frequency spectrum and the power spectrum, and detect the presences of wind noise and voice based on the extracted features.

For example, the frequency spectrum and/or the power spectrum of the collected audio signal may be obtained by a Fourier transform. For example, the Fourier transform may be or correspond to at least one of a discrete Fourier transform, a fast Fourier transform, a discrete cosine transform, a discrete sine transform, and a wavelet transform. If the audio signal is obtained in the form of analog signal, an analog-to-digital converter (not shown) may convert the audio signal into a digital signal; however, example embodiments are not limited thereto.

The audio processor 120 may extract features from the frequency spectrum and the power spectrum of the audio signals. For example, the extracted features may include at least one of low-frequency band energy, zero crossing rate in time domain, sub-band centroid, high-frequency band energy, high-frequency band energy ratio and magnitude-square coherence coefficient.

In some example embodiments, the presence of the wind noise in the audio signal may be detected according to or based on at least one of the zero crossing rate of the audio signal in time domain, the sub-band centroid (or referred to as the sub-band spectruml centroid) of the audio signal, and the low-frequency band energy of the audio signal (e.g. the energy of a fixed, variable, or predetermined frequency band whose upper limit is less than the first threshold). For example, when the zero crossing rate, the sub-band centroid and the low-frequency band energy are greater than the respective thresholds, it may be determined that there is wind noise in the audio signal. However, example embodiments are not limited thereto, and whether there is wind noise in the audio signal may be detected by other various wind noise detection techniques.

In some example embodiments, the presence of voice in the audio signal may be detected according to or based on at least one of the high-frequency band energy of the audio signal (e.g. the energy of a fixed, variable, or predetermined frequency band whose lower limit is greater than the second threshold, and the first threshold is less than the second threshold) and the high-frequency band energy ratio (e.g., the ratio of high-frequency band energy to total energy).

In addition, due to the differences in spatial arrangement of multiple microphones, wind noise energies of multiple microphones are different. In other words, wind noise signals in the audio signals obtained from multiple microphones have less coherence, while the voice signals have greater coherence. Therefore, the presence of voice may also be detected based on the coherence between the plurality of audio signals.

For example, the magnitude-square coherence coefficient C_{xy}(λ, μ) of two audio signals among a plurality of audio signals may be calculated based on the following equations (1)-(3). For an audio signal obtained from one microphone, another audio signal may be selected from (or alternatively, include at least one of) other audio signals based on the positions of other microphones, to calculate the magnitude-square coherence coefficient MSC(λ) between the two audio signals, for detecting the presence of voice. For example, the audio signal of the microphone closest to the one microphone may be selected to calculate MSC(λ). However, this is only an example, and the manner of selecting the audio signal for calculating MSC(λ) is not limited thereto.

$${C}_{xy} ( λ , μ ) = \frac{{\vert {\hat{Φ}}_{xy} ( λ , μ ) \vert}^{2}}{{\hat{Φ}}_{xx} ( λ , μ ) {\hat{Φ}}_{yy} ( λ , μ )} \qquad ( 1 )$$

$${\hat{Φ}}_{xx} ( λ , μ ) = α \cdot {\hat{Φ}}_{xx} ( λ - 1 , μ ) + ( 1 - α ) \cdot X ( λ , μ ) \cdot {X}^{*} ( λ , μ ) \qquad ( 2 )$$

$${\hat{Φ}}_{xy} ( λ , μ ) = α \cdot {\hat{Φ}}_{xy} ( λ - 1 , μ ) + ( 1 - α ) \cdot X ( λ , μ ) \cdot {Y}^{*} ( λ , μ ) \qquad ( 3 )$$

In equations (1)-(3), X(λ, μ) and Y(λ, μ) respectively denote a frequency spectrum of audio signals obtained from two microphones, A denotes a frame number, y represents a frequency point, \hat{Φ}ₓₓ and \hat{Φ}_{yy}, respectively denote an auto-correlation power spectrum of two audio signals (for example, an smoothed auto-correlation power spectrum), and \hat{Φ}_{xy} denotes a cross-correlation power spectrum of two audio signals. X* and Y* respectively denote conjugations of X and Y, α denotes a smoothing coefficient and ranges from 0 to 1. For example, α=0.95.

Since most of the energy of wind noise is distributed in the low-frequency band, the average of the magnitude-square coherence coefficients in the high-frequency band (for example, 500 Hz to 3000 Hz) may be calculated as the magnitude-square coherence coefficient MSC(λ). The low frequency band may be a band below a first threshold frequency and the high frequency band may be above a second frequency.

For example, the magnitude-square coherence coefficient MSC(λ) of two audio signals may be obtained with reference to the following equation (4). In equation (4), μ₅₀₀ and μ₃₀₀₀ respectively denote frequency point index corresponding to 500 Hz and 3000 Hz.

$$MSC ( λ ) = \frac{{\sum }_{μ = {μ}_{500}}^{{μ}_{3000}} {C}_{xy} ( λ , μ )}{{μ}_{3000} - {μ}_{500}} \qquad ( 4 )$$

For example, when the high-frequency band energy, the high-frequency band energy ratio and the magnitude-square coherence coefficient are greater than their respective thresholds, it may be determined that there is voice in the audio signal. However, example embodiments are not limited thereto, and whether there is voice in the audio signal may be detected by other various voice activity detection techniques.

In step 230, the audio processor 120 determines one of the plurality of audio signals as a reference signal according to or based on the result of detecting the presences of wind noise and voice. The audio processor 120 may determine an audio signal with lower wind noise among the plurality of audio signals as a reference signal, by using low-frequency band energy, high-frequency band energy and signal-to-noise ratio.

Taking the microphone unit including two microphones as an example. If the presence of wind noise is detected in only one audio signal, the other audio signal in which the presence of wind noise is not detected may be determined as the reference signal. If the presence of wind noise and the presence of voice are detected in both audio signals, the audio signal, with a lower signal-to-noise ratio in low-frequency band (for example, a range less than 300 Hz) of the two audio signals, may be determined as the reference signal. If the presence of wind noise is detected in both audio signals and the presence of voice is not detected in both audio signals, the audio signal, with lower low-frequency band (e.g., a range less than 100 Hz) energy of the two audio signals, may be determined as the reference signal. If the presence of wind noise is not detected in both audio signals, no compensation operation is performed.

In the case that the microphone unit includes more than two microphones, the reference signal may be determined as follows.

If the presence of wind noise is not detected only in one audio signal, the one audio signal may be determined as the reference signal.

If the presence of wind noise is not detected in at least two audio signals, the reference signal may be determined based on the presence of voice in the at least two audio signals. For example, if the presence of voice is not detected in any of the at least two audio signals, any one of the at least two audio signals may be determined as the reference signal. For example, if the presence of voice is detected in all of the at least two audio signals, the audio signal with the highest high-frequency band energy among the at least two audio signals may be determined as the reference signal.

If the presence of wind noise is detected in all the plurality of audio signals, the reference signal may be determined based on the presence of voice in the plurality of audio signals. For example, if the presence of voice is detected in all the plurality of audio signals, the audio signal with the lowest signal-to-noise ratio in the low-frequency band may be determined as the reference signal. For example, if the presence of voice is not detected in any of the plurality of audio signals, the audio signal with the lowest energy in the low-frequency band may be determined as the reference signal.

If the presence of wind noise is not detected in any of the plurality of audio signals, no compensation operation is performed.

In step 240, the audio processor 120 performs compensation operation on each of (or alternatively, at least one of) the remaining audio signals of the plurality of audio signals, based on the determined reference signal.

Due to the differences in spatial arrangement of multiple microphones, the wind noise energies of multiple microphones are different. In other words, the wind noise signals in the audio signals obtained from multiple microphones have less coherence, while the voice signals of multiple microphones have greater coherence. Thus, the audio processor 120 may, for example, with an audio signal with lower wind noise as a reference signal, compensate each of (or alternatively, at least one of) the remaining audio signals with higher wind noise by using an adaptive filter.

Because of the high coherence of voice signals in multiple audio signals, as the convergence of the filter, the energy spectrum of voice signal in the output signal of the filter will gradually approach the energy spectrum of input signal (for example, audio signal with higher wind noise), while the energy spectrum of the wind noise signal in the output signal is much smaller than that in the input signal. Therefore, compared with the input signal, the wind noise in the output signal is significantly suppressed.

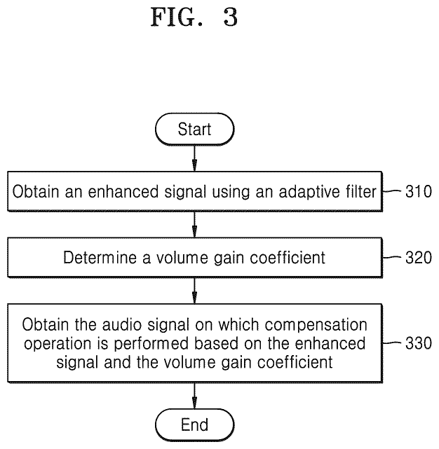

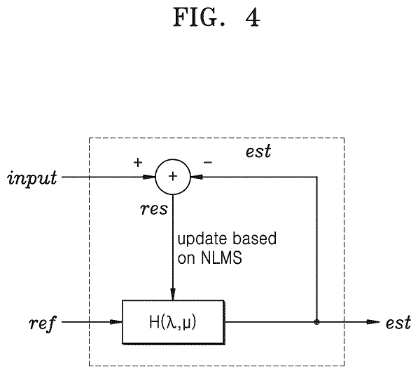

The process of the compensation operation will be described in detail later in connection with FIGS. 3-4.

In step 250, the audio processor 120 obtains modified audio signals based on the audio signals on which the compensation operation is performed. For example, the audio processor 120 may perform an inverse Fourier transform on the audio signals on which the compensation operation is performed, to obtain audio signals in time domain.

For example, the audio processor 120 may perform at least one of an inverse discrete Fourier transform, an inverse fast Fourier transform, an inverse discrete cosine transform, an inverse discrete sine transform, and an inverse wavelet transform. However, example embodiments are not limited thereto.

In some example embodiments, the collected audio signal may be divided into a plurality of frames (e.g., audio signals with fixed, variable, or predetermined period), the method of suppressing wind noise of microphone in FIG. 2 may be performed in units of a frame so as to correct each frame, and the corrected frames may be combined and/or overlapped to obtain the final audio signal.

FIG. 3 shows a flowchart of a method of performing compensation operation according to some example embodiments, and FIG. 4 is a block diagram illustrating an example structure of an adaptive filter according to some example embodiments. Although FIG. 3 illustrates various steps, an order of the steps is not necessarily limited to the order presented in FIG. 3.

The steps in FIG. 3 may be performed on each of the remaining audio signals among a plurality of audio signals, except the audio signal determined as the reference signal.

Referring to FIG. 3, in step 310, the audio processor 120 may obtain an enhanced signal using an adaptive filter.

Referring to FIG. 4, the input signal input of the adaptive filter (the portion within the dashed block in FIG. 4) is an audio signal with higher wind noise of the plurality of audio signals (e.g., an audio signal to be compensated), the reference input signal ref of the adaptive filter is the reference signal determined in step 230 (e.g., an audio signal with lower wind noise or no wind noise of the plurality of audio signals), and the output signal est of the adaptive filter is the enhanced signal.

The adaptive filter may adopt a normalized least mean square NLMS algorithm with variable step size. Referring to FIG. 4, the parameter H(λ, μ) of the filter may be updated according to the NLMS algorithm, based on a residual signal res, wherein the residual signal res is a difference between the input signal input and the output signal est of the adaptive filter.

The following equations (5)-(9) show an example of NLMS algorithm, but the present disclosure is not limited thereto, and other algorithms may also be adopted to update the parameters of the adaptive filter.

$$est ( λ , μ ) = ref ( λ , μ ) * H ( λ , μ ) \qquad ( 5 )$$

$$res ( λ , μ ) = fft ( input ( n ) - ifft ( est ( λ , μ ) ) ) \qquad ( 6 )$$

$$H ( λ + 1 , μ ) = H ( λ , μ ) + η \times ref ( λ , μ ) \times \frac{res ( λ , μ )}{max ( {P}_{xx} ( λ , μ ) , erl * {P}_{rr} ( λ , μ ) )} \qquad ( 7 )$$

$${P}_{xx} ( λ , μ ) = {\vert ref ( λ , μ ) \vert}^{2} \qquad ( 8 )$$

$${P}_{rr} ( λ , μ ) = {P}_{rr} ( λ - 1 , μ ) + θ \times ( {\vert res ( λ , μ ) \vert}^{2} - {P}_{rr} ( λ - 1 , μ ) ) \qquad ( 9 )$$

In the above equations, H(λ, μ) denotes the parameters of the filter, A denotes a frame number, μ denotes a frequency point, fft and ifft denote Fourier transform and inverse Fourier transform respectively, π denotes a filter update step, erl denotes a filter update coefficient, Pₓₓ(λ, μ) denotes a power spectrum of the reference signal ref, and Pᵣᵣ(λ, μ) denotes a power spectrum of the residual signal res. Pᵣᵣ(λ, μ) may be smoothed according to equation (9), wherein 0 denotes a smoothing coefficient, and the initial value of Pᵣᵣ(λ, μ) may be 0.

Referring to equation (7), unlike the conventional NLMS algorithm, the parameters of the filter are not only associated with the power spectrum Pₓₓ(λ, μ) of the reference signal, but also with the power spectrum Pᵣᵣ(λ, μ) of the residual signal. Through such design, when the residual signal res is large, the update rate of the filter may be reduced, and thus the convergence of the filter may be optimized or improved.

In step 320, the audio processor 120 may determine a volume gain coefficient.

For example, the volume gain coefficient may be calculated based on a ratio of the high-frequency band energy of the input signal of the filter and the high-frequency band energy of the output signal (e.g., the enhanced signal) of the filter. For example, the ratio of the high-frequency band energy of the input signal and the high-frequency band energy of the output signal of the filter in the range of 200 Hz to 4000 Hz may be calculated, but the present disclosure is not limited thereto.

In addition, the calculated volume gain coefficient may be limited within a predetermined (or alternatively, desired) threshold range. For example, when the calculated volume gain coefficient is greater than a first gain threshold, the first gain threshold may be determined as the volume gain coefficient, and when the calculated volume gain coefficient is less than a second gain threshold, the second gain threshold may be determined as the volume gain coefficient, the second gain threshold being less than the first gain threshold. In one example, the predetermined (or alternatively, desired) threshold range may be a range from 1 to 5. For example, when the volume gain coefficient calculated as described above is less than 1, the volume gain coefficient may be determined as 1; and when the volume gain coefficient calculated as described above is greater than 5, the volume gain coefficient may be determined as 5. However, this is only an example, and the threshold range of the volume gain coefficient may be arbitrarily selected.

In step 330, the audio processor 120 may obtain the audio signal on which compensation operation is performed based on the enhanced signal and the volume gain coefficient.

For example, each of (or alternatively, at least one of) the audio signals on which compensation operation is performed may be calculated as a product of the enhanced signal and the volume gain coefficient.

According to the method for suppressing wind noise based on some example embodiments of the inventive concepts, by considering the coherence of audio signals of multiple microphones (e.g., the low coherence of wind noise and the high correlation of voice), the audio signal with lower wind noise may be used as the reference signal to compensate other audio signals with higher wind noise, so that the low-frequency components of the audio signal may be kept while wind noise is suppressed, and the voice distortion may be reduced.

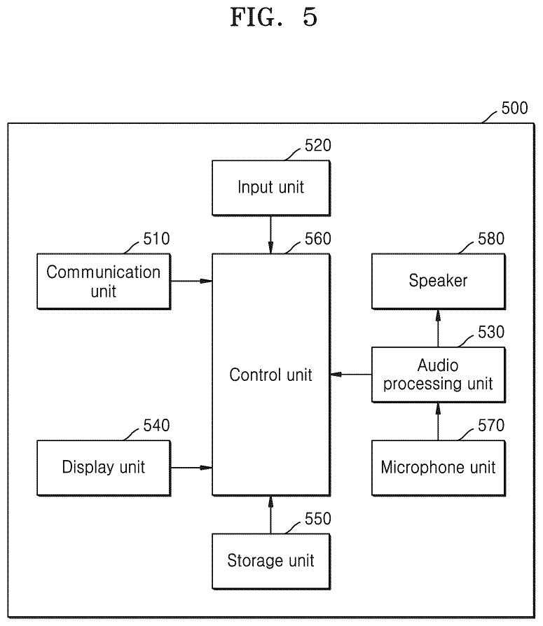

FIG. 5 shows a block diagram of a mobile terminal according to some example embodiments.

As shown in FIG. 5, the mobile terminal 500 according to some example embodiments of inventive concepts includes a communication unit 510, an input unit 520, an audio processing unit 530, a display unit 540, a storage unit 550, a control unit 560, a microphone unit 570, and a speaker 580.

The communication unit 510 may perform a communication operation for the mobile terminal. The communication unit 510 may establish a communication channel to the communication network and/or may perform communication associated with, for example, a voice call, a video call, and/or a data call. The communication unit 510 may include a transceiver, antenna, hardwire port and/or other communication hardware. The communication unit 510 may communicate the output signal with the reduced wind noise to another electronic device.

The input unit 520 is configured to receive various input information and various control signals, and to transmit the input information and control signals to the control unit 560. The input unit 520 may be realized by various input devices such as keypads and/or key boards, touch screens and/or styluses, mice, etc.; however, example embodiments are not limited thereto.

The audio processing unit 530 is connected to the microphone unit 570 and the speaker 580. The microphone unit 570 is used to collect external audio signals, for example, during calls and/or sound recording. The audio processing unit 530 processes the audio signal collected by the microphone unit 570 (for example, using the method of suppressing the wind noise of the microphone shown in FIG. 2), and transmits the processed audio signal to the control unit 560. The control unit 560 may transmit the processed audio signal in digital form via the communication unit 510 and/or may store the processed audio signal in the storage unit 550. The audio processing unit 530 converts the digital audio signal from the control unit 560 into an analog audio signal for outputting to the outside through the speaker 580. The audio processing unit 530 may be similar to or the same as the audio processor 120 of FIG. 1. The speaker 580 may output the output signal with the reduced wind noise.

The display unit 540 is used to display various information and may be realized, for example, by a touch screen; however, example embodiments are not limited thereto.

The storage unit 550 may include volatile memory and/or nonvolatile memory. The storage unit 550 may store various data generated and used by the mobile terminal. For example, the storage unit 550 may store an operating system (OS) and applications (e.g., applications associated with the method of inventive concepts) for controlling the operation of the mobile terminal. The control unit 560 may control the overall operation of the mobile terminal and may control part or all of the internal elements of the mobile terminal. The control unit 560 may be implemented as general-purpose processor, application processor (AP), application specific integrated circuit, field programmable gate array, etc., but example embodiments are not limited thereto. The storage unit 550 may have the output audio signal with the reduced wind noise stored thereon.

In some example embodiments, the audio processing unit 530 and the control unit 560 may be implemented by the same device and/or integrated in a single chip.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions and/or software include machine code that is directly executed by the processor or computer, such as machine code produced by a compiler. In another example, the instructions or software include higher-level code that is executed by the processor or computer using an interpreter. Persons and/or programmers of ordinary skill in the art may readily write the instructions and/or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

Any of the elements and/or functional blocks disclosed above may include or be implemented in processing circuitry such as hardware including logic circuits; a hardware/software combination such as a processor executing software; or a combination thereof. For example, the control unit 560 and audio processing unit 530 may be implemented as processing circuitry. The processing circuitry specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Processor(s), controller(s), and/or processing circuitry may be configured to perform actions or steps by being specifically programmed to perform those action or steps (such as with an FPGA or ASIC) or may be configured to perform actions or steps by executing instructions received from a memory, or a combination thereof.

While various example embodiments have been described, it will be apparent to one of ordinary skill in the art that various changes in form and details may be made in these examples without departing from the spirit and scope of the claims and their equivalents.

What is claimed is:

1. A method of suppressing wind noise of microphone comprising:
receiving a plurality of audio signals from a plurality of microphones;
detecting presences of wind noise and voice in the plurality of audio signals;
determining one of the plurality of audio signals as a reference signal based on a result of detecting the presences of wind noise and voice, the plurality of audio signals including the one of the plurality of audio signals and remaining audio signals; and
performing compensation operation on each of the remaining audio signals based on the determined reference signal; and
obtaining modified audio signals based on the remaining audio signals on which the compensation operation is performed.

2. The method of claim 1, wherein the detecting the presences of wind noise and voice in the plurality of audio signals comprises:
obtaining a frequency spectrum and a power spectrum of each of the plurality of audio signals;
extracting features from the plurality of audio signals based on the frequency spectrum and the power spectrum; and
detecting the presences of wind noise and voice in the plurality of audio signals based on the extracted features.

3. The method of claim 2, wherein the extracted features comprise at least one of low-frequency band energy, zero crossing rate, sub-band centroid, high-frequency band energy, high-frequency band energy ratio and magnitude-square coherence coefficient, and
wherein the magnitude-square coherence coefficient is an average of magnitude-square coherence coefficients in a high-frequency band.

4. The method of claim 3, wherein the detecting the presences of wind noise and voice in the plurality of audio signals based on the extracted features comprises:
for each of the plurality of audio signals, detecting whether there is wind noise based on at least one of the low-frequency band energy, the zero crossing rate and the sub-band centroid, and detecting whether there is voice based on at least one of the high-frequency band energy, the high-frequency band energy ratio, and the magnitude-square coherence coefficient.

5. The method of claim 1, wherein the determining of the reference signal comprises:
in response to the presence of wind noise not being detected only in one audio signal among the plurality of audio signals, determining the one audio signal as the reference signal;
in response to the presence of wind noise not being detected in at least two audio signals among the plurality of audio signals, determining the reference signal based on the presence of voice in the at least two audio signals, wherein in response to the presence of voice not being detected in any of the at least two audio signals, any one of the at least two audio signals is determined as the reference signal, and in response to the presence of voice being detected in all of the at least two audio signals, an audio signal with a highest high-frequency band energy among the at least two audio signals is determined as the reference signal; and
in response to the presence of wind noise being detected in all the plurality of audio signals, determining the reference signal based on the presence of voice in the plurality of audio signals, wherein in response to the presence of voice being detected in all the plurality of audio signals, an audio signal with the lowest signal-to-noise ratio in a low-frequency band among the plurality of audio signals is determined as the reference signal, and in response to the presence of voice not being detected in any of the plurality of audio signals, an audio signal with a lowest energy in the low-frequency band among the plurality of audio signals is determined as the reference signal.

6. The method of claim 1, wherein the performing compensation operation on each of the remaining audio signals comprises:
obtaining an enhanced signal using an adaptive filter, wherein an input signal of the adaptive filter is the one of the plurality of audio signals on which compensation operation is to be performed, and a reference input signal of the adaptive filter is the reference signal;
determining a volume gain coefficient; and
obtaining the one of the plurality of audio signals on which the compensation operation is performed based on the enhanced signal and the volume gain coefficient.

7. The method of claim 6, wherein the determining of the volume gain coefficient comprises:
calculating the volume gain coefficient through a ratio of high-frequency band energy of the input signal of the adaptive filter and high-frequency band energy of the enhanced signal,
wherein, in response to the calculated volume gain coefficient being greater than a first threshold, determining the first threshold as the volume gain coefficient, and
wherein, in response to the calculated volume gain coefficient being smaller than a second threshold, determining the second threshold as the volume gain coefficient, the second threshold being smaller than the first threshold.

8. The method of claim 6, wherein a normalized least mean square algorithm with variable step size is adopted by the adaptive filter, and parameters of the adaptive filter are related to power spectrum of a residual signal of the adaptive filter, the residual signal of the adaptive filter being calculated based on a difference between the input signal and an output signal of the adaptive filter.

9. An electronic device comprising:
a microphone unit configured to collect a plurality of audio signals, wherein the microphone unit includes a plurality of microphones, and each of the microphones collects one of the plurality of audio signals; and
an audio processor configured to,
receive the plurality of audio signals from the plurality of microphones;
detect presences of wind noise and voice in the plurality of audio signals;
determine one of the plurality of audio signals as a reference signal, based on a result of detecting the presences of wind noise and voice, the plurality of audio signals including the one of the plurality of audio signals and remaining audio signals;
perform a compensation operation on each of the remaining audio signals of the plurality of audio signals, based on the determined reference signal; and
obtain modified audio signals based on the remaining audio signals on which the compensation operation is performed.

10. The electronic device of claim 9, wherein the audio processor is configured to:
obtain a frequency spectrum and a power spectrum of each of the plurality of audio signals;
extract features from the plurality of audio signals based on the frequency spectrum and the power spectrum; and
detect the presences of wind noise and voice in the plurality of audio signals based on the extracted features.

11. The electronic device of claim 10, wherein the extracted features comprise at least one of low-frequency band energy, zero crossing rate, sub-band centroid, high-frequency band energy, high-frequency band energy ratio and magnitude-square coherence coefficient, and
wherein the magnitude-square coherence coefficient is an average of the magnitude-square coherence coefficients in a high-frequency band.

12. The electronic device of claim 11, wherein the audio processor is configured to,
for each of the plurality of audio signals, detect whether there is wind noise based on at least one of the low-frequency band energy, the zero crossing rate and the sub-band centroid, and detect whether there is voice based on at least one of the high-frequency band energy, the high-frequency band energy ratio and the magnitude-square coherence coefficient.

13. The electronic device of claim 9, wherein the audio processor is configured to,
in response to the presence of wind noise not being detected only in one audio signal, determine the one audio signal as the reference signal;
in response to the presence of wind noise not being detected in at least two audio signals among the plurality of audio signals, determine the reference signal based on the presence of voice in the at least two audio signals, wherein in response to the presence of voice not being detected in any of the at least two audio signals, any one of the at least two audio signals is determined as the reference signal, and in response to the presence of voice being detected in all of the at least two audio signals, an audio signal with a highest high-frequency band energy among the at least two audio signals is determined as the reference signal; and
in response to the presence of wind noise being detected in all the plurality of audio signals, determine the reference signal based on the presence of voice in the plurality of audio signals, wherein in response to the presence of voice being detected in all the plurality of audio signals, an audio signal with the lowest signal-to-noise ratio in a low-frequency band among the plurality of audio signals is determined as the reference signal, and in response to the presence of voice not being detected in any of the plurality of audio signals, an audio signal with a lowest energy in the low-frequency band among the plurality of audio signals is determined as the reference signal.

14. The electronic device of claim 9, wherein the audio processor is configured to,
obtain an enhanced signal using an adaptive filter, wherein an input signal of the adaptive filter is the one of the plurality of audio signals on which compensation operation is to be performed, and a reference input signal of the adaptive filter is the reference signal;
determine a volume gain coefficient; and
obtain the one of the plurality of audio signals on which the compensation operation is performed based on the enhanced signal and the volume gain coefficient.

15. The electronic device of claim 14, wherein the audio processor is configured to,
calculate the volume gain coefficient through a ratio of high-frequency band energy of the input signal of the adaptive filter and high-frequency band energy of the enhanced signal,
wherein, in response to the calculated volume gain coefficient being greater than a first threshold, determine the first threshold as the volume gain coefficient, and
wherein, in response to the calculated volume gain coefficient being smaller than a second threshold, determine the second threshold as the volume gain coefficient, the second threshold being smaller than the first threshold.

16. The electronic device of claim 14, wherein a normalized least mean square algorithm with variable step size is adopted by the adaptive filter, and parameters of the adaptive filter are related to power spectrum of a residual signal of the adaptive filter, the residual signal of the adaptive filter being calculated based on a difference between the input signal and an output signal of the adaptive filter.

17. A non-transitory computer-readable storage medium storing instructions that, when executed by a processor, cause the processor to execute the method of claim 1.
